(19) United States
(12) Patent Application Publication
(10) Pub. No.: US 2004/0054653 A1
(43) Pub. Date: Mar. 18, 2004

(54) Method and equipment for managing interactions in the MPEG-4 standard

(75) Inventors: Jean-Claude Dufourd, Le Kremlin-Bicetre (FR); Cyril Concolato, Gentilly (FR); Francoise Preteux, Paris (FR); Marius Preda, Evry (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignees: Groupe des Ecoles des Telecommunications, a French corporation, Paris Cedex (FR); France Telecom, a French corporation, Paris (FR)

(21) Appl. No.: 10/620,130

(22) Filed: Jul. 15, 2003

Related U.S. Application Data
(63) Continuation of application No. PCT/FR02/00145, filed on Jan. 15, 2002.

(30) Foreign Application Priority Data
Jan. 15, 2001 (FR) 01/00486
Feb. 7, 2001 (FR) 01/01648

(51) Int. Cl. G06F 7/00

(52) U.S. Cl. 707/1

(57) ABSTRACT

A method for managing interactions between at least one peripheral command device and at least one multimedia application exploiting the standard MPEG-4. A peripheral command device delivers digital signals as a function of actions of one or more users comprising: constructing a digital sequence having the form of a BIFS node (Binary Form for Scenes in accordance with the standard MPEG-4), a node comprising at least one field defining a type and a number of interaction data to be applied to objects of a scene.

### RELATED APPLICATION

This is a continuation of International Application No. PCT/FR02/00145, with an international filing date of Jan. 15, 2002, which is based on French Patent Application Nos. 01/00486, filed Jan. 15, 2001, and 01/01648, filed Feb. 7, 2001.

### FIELD OF THE INVENTION

This invention pertains to management of multimedia interactions performed by one or more users from multimedia terminals. The interactions can be text-based, vocal or gestural. The interactions may be input by any conventional input device such as a mouse, joystick, keyboard or the like, or a nonconventional input device such as recognition and voice synthesis systems or interfaces controlled visually and/or by gesture. These multimedia interactions are processed in the context of the international standard MPEG-4.

### BACKGROUND

The standard MPEG-4 (ISO/IEC 14496) specifies a communication system for interactive audiovisual scenes. The standard ISO/IEC 14496-1 (MPEG-4 Systems) defines the scene description binary format (BIFS: BInary Format for Scenes) which pertains to the organization of audiovisual objects in a scene. The actions of the objects and their responses to the interactions performed by the users can be represented in the BIFS format by means of sources and targets (routes) of events as well as by means of sensors (special nodes capable of triggering events). The client-side interactions consist of the modification of the attributes of the objects of the scene according to the actions specified by the users. However, MPEG-4 systems do not define a particular user interface or a mechanism which associates the user interaction with the BIFS events.

BIFS-Command is the subset of the BIFS description which enables modifications of the graphic properties of the scene, its nodes or its actions. BIFS-Command is therefore used to modify a set of scene properties at a given moment. The commands are grouped together in CommandFrames to enable sending multiple commands in a single Access Unit. The four basic commands are the following: replacement of an entire scene, and insertion, removal or replacement of node structures, input of events (eventIn), exposedField, value indexed in an MFField or route. Identification of a node in a scene is provided by a nodeID. Identification of the fields of a node is provided by the INid of the field.

BIFS-Anim is the subset of the BIFS description pertaining to the continuous updating of certain node fields in the graphic of the scene. BIFS-Anim is used to integrate different types of animation, including the animation of models of faces, human bodies and meshing, as well as various types of attributes such as two-dimensional and three-dimensional positions, rotations, scale factors or colorimetric information. BIFS-Anim specifies a flow as well as coding and decoding procedures for animating certain nodes of the scene that comprise particular dynamic fields. The major drawback of BIFS-Anim is the following: BIFS-Anim does not specify how to animate all of the fields capable of being updated of all of the nodes of a scene. Moreover, BIFS-Anim uses an animation mask that is part of the decoder configuration information. The animation mask can not be modified by a direct interaction of a user. BIFS-Anim is therefore not suitable for user interaction requiring a high level of flexibility and the possibility of causing dynamic development of the nodes of the scene to be modified.

MPEG-J is a programming system which specifies the interfaces to ensure the interoperability of an MPEG-4 media diffuser with Java code. The Java code arrives at the MPEG-4 terminal level in the form of a distinct elementary flow. It is then directed to the MPEG-J execution environment which comprises a virtual Java machine from which the MPEG-J program will have access to the various components of the MPEG-4 media diffuser. The SceneGraph programming interface provides a mechanism by which the MPEG-J applications access the scene used for the composition by the BIFS media diffuser and manipulate it. It is a low level interface allowing the MPEG-J application to control the events of the scene and modify branching of the scene by program. Nodes can also be created and manipulated, but only the fields of the nodes for which a node identification was defined are accessible to the MPEG-J application. Moreover, implementation of MPEG-J requires excessively large resources for numerous applications especially in the case of portable devices of small size and decoders. Thus, MPEG-J is not suitable for the definition of user interaction procedures available on terminals of limited capacity.

The analysis of the state of the art presented above briefly described and examined the principal procedures that can be used to manage the interactions of multimedia users. This should be supplemented by aspects relative to the current interaction management architectures. Until now there have been two ways to approach the interaction. First, in the MPEG-4 context and solely for pointer type interactions, the composition device is in charge of transcoding the events stemming from the users into scene modification action. Second, outside of the context of the MPEG-4 standard, the interactions other than those of pointer type must be implemented in a specific application. Consequently, interoperability is lost. The two previously described options are too limited for attaining in its generality and genericity the concept of multi-user interactivity which has becomes the principal goal of communication systems.

Known in the state of the art is patent WO 00/00898 which pertains to a multi-user interaction for a multimedia communication which consists of generating a message on a local user computer, the message containing the object-oriented media data (e.g., a flow of digital audio data or a flow of digital video data or both), and transmitting the message to a remote user computer. The local user computer displays a scene comprising the object-oriented media data and distributed between the local user computer and the remote user computer. The remote user computer constructs the message by means of a sort of message manager. The multi-user interaction for the multimedia communication is an extension of MPEG-4, Version 1.

WO 99/39272 pertains to an interactive communication system based on MPEG-4 in which command descriptors are used with command routing nodes or server routing pathways in the scene description to provide a support for the specific interactivity for the application. Assistance in the selection of the content can be provided by indicating the presentation in the command parameters, the command identifier indicating that the command is a content selection command. It is possible to create an initial scene comprising multiple images and a text describing a presentation associated with an image. A content selection descriptor is associated with each image and the corresponding text. When the user clicks on an image, the client transmits the command containing the selected presentation and the server launches a new presentation. This technique can be implemented in any application context in the same way that one can use HTTP and CGI to implement any server-based application functionality.

### SUMMARY OF THE INVENTION

This invention relates to a method for managing interactions between at least one peripheral command device and at least one multimedia application exploiting the standard MPEG-4, the peripheral command device delivering digital signals as a function of actions of one or more users including constructing a digital sequence having the form of a BIFS node (Binary Form for Scenes in accordance with the standard MPEG-4), the node including at least one field defining a type and a number of interaction data to be applied to objects of a scene.

This invention also relates to computer equipment including a calculator for executing a multimedia application exploiting the standard MPEG-4, at least one peripheral device for representing a multimedia scene, at least one peripheral device for commanding the application, an interface circuit including an input circuit for receiving signals from a command means and an output circuit for delivering a BIFS sequence, and means for constructing an output sequence as a function of signals provided by the peripheral input device.

### BRIEF DESCRIPTION OF THE DRAWINGS

Better comprehension of the invention will be obtained from the description below pertaining to a nonlimitative example of implementation with reference to the attached drawings in which:

FIG. 1 represents the flow chart of the decoder model of the system, and

FIG. 2 represents the user interaction data flow.

### DETAILED DESCRIPTION

This invention provides methods and a system for managing the multimedia interactions performed by one or more users from a multimedia terminal. The system is an extension of the specifications of the MPEG-4 Systems part. It specifies how to associate single-user or multi-user interactions with BIFS events by reusing the architecture of the MPEG-4 Systems. The system linked to the invention is generic because it enables processing of all types of single-user or multi-user interactions from input devices which can be simple (mouse, keyboard) or complex (requiring taking into account 6 degrees of freedom or implementing voice recognition systems). By the simple reuse of existing tools, this system can be used in all situations including those that can only support a very low level of complexity.

In the invention, which relates to single-user or multi-user multimedia interaction, the interaction data generated by an input device of any type are handled as elementary MPEG-4 flows. The result is that operations similar to those applied to any elementary data flow can then be implemented by using directly the standard decoding sequence.

The invention pertains in its broadest sense to a procedure for the management of interactions between peripheral command devices and multimedia applications exploiting the standard MPEG-4, the peripheral command devices delivering digital signals as a function of actions of one or more users. The method comprises a step of constructing a digital sequence having the form of a BIFS node (Binary Form for Scenes in accordance with the standard MPEG-4), this node comprising one or more fields defining the type and the number of interaction data to be applied to the objects of the scene.

According to a preferred mode of implementation, the node comprises a flag whose status enables or prevents an interaction to be taken into account by the scene. According to a variant, the node comprises a step of signalization of the activity of the associated device.

The procedure advantageously comprises a step of designation of the nature of the action or actions to be applied to one or more objects of the scene by the intermediary of the node field(s). According to a preferred mode of implementation, the procedure comprises a step of construction from one or more node fields of another digital sequence composed of at least one action to be applied to the scene and of at least one parameter of the action, the value of which corresponds to a variable delivered by the peripheral device.

According to a preferred mode of implementation, the procedure comprises a step of transferring said digital sequence into the composition memory. According to a preferred mode of implementation, the transfer of the digital sequence uses the decoding sequence of MPEG-4 systems for introducing the interaction information into the composition device. According to a particular mode of implementation, the sequence transfer step is performed under the control of a flow comprising at least one flow descriptor, itself transporting the information required for the configuration of the decoding sequence with the appropriate decoder.

According to a variant, the step comprising construction of said sequence is performed in a decoder equipped with the same interface with the composition device as an ordinary BIFS decoder for executing the decoded BIFS-Commands on the scene without passing through a composition buffer.

According to a variant, the BIFS node implementing the first construction step comprises a number of variable fields, dependent on the type of peripheral command devices used, the fields are connected to the fields of the nodes to be modified by the routes. The interaction decoder then transfers the values produced by the peripheral devices into the fields of this BIFS node, the route mechanisms being assigned to propagate these values to the target fields.

According to a particular mode of implementation, the flow of single-user or multi-user interaction data passes through a DMIF client associated with the device which generates the access units to be placed in the decoding buffer memory linked to the corresponding decoder. According to a specific example, the single-user or multi-user interaction flow enters into the corresponding decoder either directly or via the associated decoding buffer memory, thereby shortening the path taken by the user interaction flow.

The invention also pertains to computer equipment comprising a calculator for the execution of a multimedia application exploiting the standard MPEG-4 and at least one peripheral device for the representation of a multimedia scene, as well as at least one peripheral device for commanding the program characterized in that it also has an interface circuit comprising an input circuit for receiving the signals from a command means and an output circuit for delivering a digital sequence, and a means for the construction of an output sequence as a function of the signals provided by the peripheral input device, in accordance with the previously described procedure.

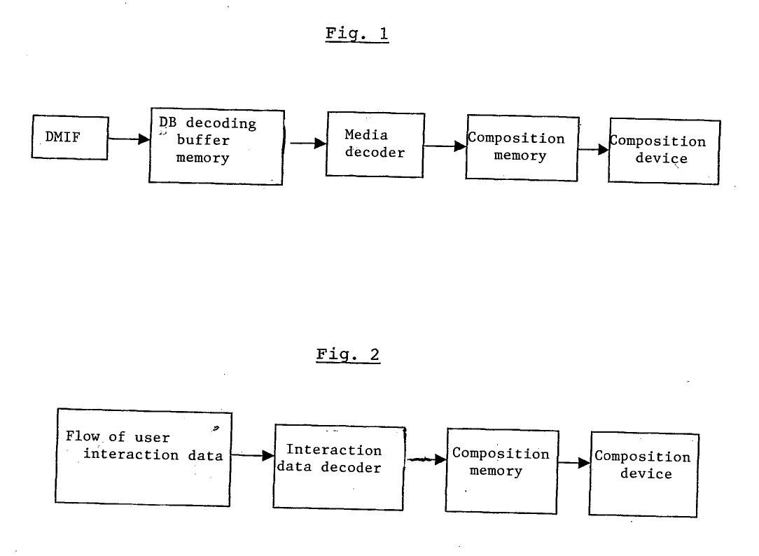

Turning now to the drawings, FIG. 1 describes the standard model. FIG. 2 describes the model in which two principal concepts appear: the interaction decoder which produces the composition units (CU) and the user interaction flow. The data can originate either from the decoding buffer memory placed in an access unit (AU), if the access to the input device manager is performed using DMIF (Delivery Multimedia Integration Framework) of the standard MPEG-4, or pass directly from the input device to the decoder itself, if the implementation is such that the decoder and input device manager are placed in the same component. In this latter case, the decoding buffer memory is not needed.

The following elements are required for managing the user interaction:

a novel type of flow taking into account the user interaction (UI) data;

a novel unique BIFS node for specifying the association between the flow of user interactions and the scene elements, and also for authorizing or preventing this interaction; and

a novel type of decoder for interpreting the data originating from the input device or alternatively from the decoding buffer memory, and for transforming them into scene modifications. These modifications have the same format as BIFS-Commands. In other words, the output of the interaction decoder is equivalent to the output of a BIFS decoder.

The novel type of flow, called user interaction flow (UI flow, see Table below), is defined here. It is composed of access units (UA) originating from an input device (e.g., a mouse, a keyboard, an instrumented glove, etc.). In order to be more generic, the syntax of an access unit is not defined here. It can be—without being limited—identical to another access unit originating from another elementary flow if the access is implemented using DMIF. The type of flow specified here also comprises the case of a local media creation device used as interaction device. Thus, a local device that produces any type of object defined by the object-type indication (Object Type Indication) of MPEG-4, such as a visual or audio object, is managed by the invention.

The syntax of the new BIFS node, called InputSensor, is as follows:

| | | | |
|---|---|---|---|
| InputSensor { | | | |
| ExposedField | SFBool | Enabled | TRUE |
| ExposedField | SFCommandBuffer | InteractionBuffer | [ ] |
| Field | SFUrl | url | “ “ |
| EventOut | SFBool | IsActive | |
| } | | | |

The “enabled” field makes it possible to monitor whether or not the user wants to authorize the interaction which originates from the user interaction flow referenced in the “url” field. This field specifies the elementary flow to be used as described in the description platform of the standard MPEG-4 object.

The field “interactionBuffer” is an SFCommandBuffer which describes what the decoder should do with the interaction flow specified in the “url”. The syntax is not obligatory but the semantic of the buffer memory is described by the following example:

| | |
|---|---|
| InputSensor { | |
| enabled | TRUE |
| InteractionBuffer | [“REPLACE N1.size”, “REPLACE N2.size”, |
| | “REPLACE N3.size”] |
| url | “4” |
| } | |

This sensor recovers at least three parameters originating from the input device associated with the descriptor of object 4 and replaces, respectively, the “size” field of the nodes N1, N2 and N3 by the received parameters.

The role of the user interaction decoder is to transform the received access units, originating either from the decoding buffer memory or directly from the input device. It transforms them into composition units (CU) and places them in the composition memory (CM) as specified by the standard MPEG-4. The composition units generated by the decoder of the user interaction flow are BIFS-Updates, more specifically the REPLACE commands, as specified by MPEG-4 Systems. The syntax is strictly identical to that defined by the standard MPEG-4 and deduced from the interaction buffer memory.

For example, if the input device generated the integer 3 and if the interaction buffer memory contains “REPLACE N1.size”, then the composition unit will be the decoded BIFS-Update equivalent to “REPLACE N1.size by 3”.

One variant replaces the interaction Buffer field of the InputSensor node by a variable field number dependent on the type of peripheral command device used, of the type EventOut. The role of the user interaction decoder is then to modify the values of these fields, assigning to the author of the multimedia presentation the creation of routes connecting the fields of the InputSensor node to the target fields in the scene tree.

1. A method for managing interactions between at least one peripheral command device and at least one multimedia application exploiting the standard MPEG-4, said peripheral command device delivering digital signals as a function of actions of one or more users comprising: constructing a digital sequence having the form of a BIFS node (Binary Form for Scenes in accordance with the standard MPEG-4), said node comprising at least one field defining a type and a number of interaction data to be applied to objects of a scene.

2. The method according to claim 1, wherein the digital sequence uses a decoding sequence of MPEG-4 systems to introduce the interaction data into the peripheral command device.

3. The method according to claim 1, further comprising designating the nature of an action or actions to apply on one or more objects of the scene by an intermediary of one or more fields of the node.

4. The method according to claim 2, further comprising designating the nature of an action or actions to apply on one or more objects of the scene by an intermediary of one or more fields of the node.

5. The method according to claim 1, wherein the BIFS node comprises a number of variable fields dependent on the type of peripheral command device, and transfer of the interaction data of fields of the node to the target fields is implemented by means of routes.

6. The method according to claim 2, wherein the BIFS node comprises a number of variable fields dependent on the type of peripheral command device, and transfer of the interaction data of fields of the node to the target fields is implemented by means of routes.

7. The method according to claim 1, further comprising signalizing activity of the device.

8. The method according to claim 2, further comprising signalizing activity of the device.

9. The method according to claim 1, wherein signal delivery is performed in the form of a flow signaled by a descriptor which contains information for configuring the decoding sequence with an appropriate decoder.

10. The method according to claim 1, wherein constructing the interaction data sequence is performed in a decoding buffer memory of a multimedia application execution terminal.

11. The method according to claim 1, wherein translation of the interaction data sequence is performed in a decoder equipped with an interface with the composition device similar to an ordinary BIFS decoder for executing the BIFS-Commands decoded on the scene.

12. The method according to claim 1, wherein flow of user interactions passes through a DMIF client associated with the device that generates access units to be placed in a decoding buffer memory linked to a corresponding decoder.

13. The method according to claim 1, wherein flow of user interactions enters into a corresponding decoder, either directly, or via an associated decoding buffer memory, thereby shortening the path taken by the user interaction flow.

14. Computer equipment comprising:
a calculator for executing a multimedia application exploiting the standard MPEG-4;
at least one peripheral device for representing a multimedia scene;
at least one peripheral device for commanding said application;
an interface circuit comprising an input circuit for receiving signals from a command means and an output circuit for delivering a BIFS sequence; and
means for constructing an output sequence as a function of signals provided by the peripheral input device, in accordance with claim 1.
